(19) United States
(12) Patent Application Publication
(10) Pub. No.: US 2014/0125614 A1
(43) Pub. Date: May 8, 2014

(54) METHOD FOR DETECTING ONE OR MORE CONDUCTIVE AREAS

(71) Applicant: PRINTECHNOLOGICS GMBH, Chemnitz (DE)

(72) Inventors: Johannes Koepcke, Dresden (DE); Matthias Foerster, Dresden (DE)

(73) Assignee: PRINTECHNOLOGICS GMBH, Chemnitz (DE)

(21) Appl. No.: 14/110,146

(22) PCT Filed: Apr. 5, 2012
(86) PCT No.: PCT/EP2012/056368

§ 371 Date: Jan. 21, 2014

Related U.S. Application Data
(60) Provisional application No. 61/472,018, filed on Apr. 5, 2011.

(30) Foreign Application Priority Data
Apr. 5, 2011 (EP) 11161156.2
Aug. 4, 2011 (EP) 11176626.7

(51) Int. Cl. G06F 3/041

(52) U.S. Cl. CPC G06F 3/0416
USPC 345/173

(57) ABSTRACT

The invention relates to a method for detecting one or more conductive areas of an information carrier by means of a touch screen.

The invention relates to a method for detecting one or more conductive areas of an information carrier by means of a touch screen.

Numerous electronic devices which have a touch-sensitive screen (touch screen), which is also referred to as a touchscreen and can be operated with fingers or input devices, are described in the prior art. These days, touch screens can be found in almost all spheres of life. Because of their intuitive operation, they make it easier particularly for the inexperienced user to operate technical equipment in the everyday world and can be used for operating an electronic device. That is to say, as well as everyday use, they are also used in industry where touch screens are employed to control machines, for example, or in the games industry sector in which they are used for gaming machines or arcade games. Further examples of touch screens include smart phones, cell phones, displays, tablet PCs, tablet notebooks touchpad devices, graphics tablets, televisions, PDAs, mobile music play-back devices and/or other input devices.

A touch screen can also be part of an input device. Input devices of this kind are used in smart phones, PDAs, touch displays and notebooks among others.

In general, a touch screen, also referred to as pushbutton screen or sensor screen, is understood to mean a touch-sensitive layer which is applied to the screen and which responds to contact by the user with his finger or, depending on the technology used, a suitable stylus. The touch screen is an input device with direct action, that is to say the input occurs directly on the displayed space, not away from the display as would be the case with mouse or keyboard for example. In addition, with the touch screen, the positioning is absolute, that is to say it is independent of the previous position. Consequently, touch screens provide extremely intuitive operation, as the screen serves simultaneously as a user interface and it is not necessary to choose a circuitous route via external input devices.

“Natural User Interfaces” (NUI) or “Reality Based User Interfaces” enable the user to interact directly with the user interface of a touchscreen by swiping, tapping or touching. Natural user interfaces such as touch screens are touch-sensitive and respond to finger and hand movements. In this context, this is also referred to as gesture-based operation. Earlier operating patterns of graphical user interfaces (GUI) have changed considerably due to the development of touch screens. While previously, artificial input devices such as a keyboard or a mouse were necessary for interaction, now a touch of a finger is all that is necessary. Smart phones, such as the Apple iPhone example, and also ticket windows and automated teller machines use this direct form of operation.

As the touching and manipulating of virtual objects works in almost exactly the same way as the real object, it is easy for the user to transfer everyday handling techniques to the digital system. Handling techniques in the real everyday environment enable parallels to be drawn with the virtual objects and handling methods to be transferred. Various pre-determined interaction options, so-called ‘patterns’, such as the scaling, moving and rotating of images or the scrolling of information, for example, enable the user to interact with the device and the software directly via the interface. NUIs enable people to interact in a very much more natural way and mean an expansion of the previously limited artificial interaction with technical interfaces.

Regardless of the technology for registering a touch point (also referred to as “touch event”, “touch-event” or “touchevent”), all touch screen technologies use three different components as the basis of their hardware: sensors, comparators and actuators. Sensors register changes to the system and, as a result of their sensitivity and range, determine the usable interactions of a multi-touch screen. Multi-touch screens have the special characteristic that they are able to process a plurality of touch events and therefore multi-touch inputs, i.e. at least two touch events, simultaneously. The task of the comparators is to carry out a state comparison. The state of the system after the interaction is compared with the state of the system before the interaction and the comparator decides the effects of the interactions which have been carried out. This is passed onto the actuators and the actual handling executed. Sensor techniques can be differentiated into the following technologies. Touch screens are based on different working principles, wherein resistive and capacitive technology are the most widespread. Resistive touch screens consist of two opposing, transparent, conductive ITO layers (indium tin oxide), which are separated from one another by numerous insulated spacers, so-called “spacer dots”. The inner ITO layer is located on a fixed glass screen; the outer layer is protected by a flexible, scratch-proof plastic film. Voltages are applied to the conductive layers by means of a control device so that a voltage gradient is produced in the X-direction on the inner layer and a voltage gradient in the Y-direction on the outer layer. As soon as the screen is touched, the upper layer is pressed onto the one beneath it, thus producing an electrical contact and changing the voltage at this point. The so-called controller then calculates the X-Y coordinates of the point touched commensurate with the applied voltage.

On the other hand, with capacitive technology, as an example, a plurality of conductor tracks made from conductive metal oxide is in each case applied to at least two planes which are spatially separated from one another, e.g. the top and bottom side of a film or of a glass substrate. Capacitors are formed at the crossing points of the horizontally running conductor tracks of the one plane and the vertically running conductor tracks of the other plane. Electrical activation of the conductor tracks of one plane therefore produces a measurable signal on the conductor tracks of the second plane. The controller then evaluates the resulting signal changes and can therefore determine the exact coordinates of the touch. As well as single-touch detection, multi-touch detections are also possible so that a plurality of fingers or input elements can initiate one or more touch events.

Furthermore, touch screens which use infrared technology, acoustic surface wave technology or dispersive signal technology are also known

For example, WO 2007/017848 A2 discloses an apparatus and a system with which information relating to an object can be determined. Here, one or more objects which incorporate one or more sensors are positioned on a surface. These sensors register capacitively whether an object is in contact with the surface or not. Based on the gathered data, a computer unit can pass on information relating to the object (speed, position or orientation) to a user. The disadvantage is that the system described in the patent is not suitable for manufacture in mass printing processes.

However, the fact that an interaction between a touch screen and an information carrier is possible is not described in the prior art. Only special input means, which simplify the input on the touch screen, are described.

The object of the invention is to provide a method, by means of which information can be assigned to inputs made by means of an information carrier via a touch screen.

The object is achieved by the independent claims. Advantageous embodiments can be seen from the dependent claims.

The invention therefore relates to a method for detecting one or more electrically conductive areas of one or more information carriers, wherein the areas are connected to one another by means of electrically conductive conductor structures and the conductor structures and the areas lie in a first surface parallel to the second surface of a touch screen and the method comprises the following steps:
a. bringing the conductive areas of the first surface of one or more information carriers into contact with the second surface of the touch screen at least in some areas,
b. initiation of one or more touch events by bringing into contact in accordance with (a), and
c. determining the positions, orientations and/or extensions of the touch events.

The invention further relates in particular to a method for detecting one or more electrically conductive areas of one or more information carriers, wherein the areas are connected to one another by means of electrically conductive conductor structures and the conductor structures and the areas lie in a first surface parallel to the second surface of a touch screen comprising the following steps:
a. bringing the conductive areas of the first surface of one or more information carriers into contact with the second surface of the touch screen at least in some areas,
b. detecting the electrically conductive areas and conductor structures by means of the touch screen and manipulating the electrical variables of the touch screen by means of the conductive areas and the conductor structures of the information carrier,
c. evaluation of the raw data, RAW view and/or a matrix with levels from the elicited manipulation.

Within the meaning of the invention, bringing into contact signifies particularly that there is preferably no free space between the information carrier and the touch screen. That is to say, the information carrier is preferably in touch-contact with the touch screen. However, it can also be preferred that there is no direct contact between the information carrier and the touch screen but only a convergence which is sufficient to initiate at least one touch event on the touch screen. It is known to the person skilled in the art that, with a touch screen, touch events can be initiated simply by a convergence. The person skilled in the art can establish what is designated as convergence within the meaning of the invention without great experimental effort, as the information carrier initiates a touch event when it is moved towards the touch screen.

Preferably, the information carrier initiates a plurality of touch events on the touch screen. Preferably, defined signal changes are generated on a touch screen by the conductive areas, which are preferably provided on the information carrier in a structured form.

It was highly surprising that not only the electrically conductive areas but also the electrically conductive conductor structures are measured by the touch screen, and as a result not only is the electrical principle of operation of a touch screen (which within the meaning of the invention can also be designated as touchscreen) affected, but that software can also be used for the downstream evaluation. That is to say, an improved and more complex evaluation of the generated touch event compared with the prior art can be carried out with the method according to the invention. The invention renounces normal technical practice. In the prior art, an attempt is made to carry out determinations of the touch event which are as accurate as possible, as essentially the center of the touch event is determined. That is to say, an increase in the diameter of the electrically conductive area which generates the touch event does not lead to a change in the touch event. On the other hand, with the method according to the invention, not only are the electrically conductive areas, but also the electrically conductive conductor structures taken into account, so that a change in the diameter nevertheless causes a change in the touch event.

It has been shown to be greatly preferred when the electrically conductive areas are substantially flat and a layer thickness of the electrically conductive areas and of the electrically conductive conductor structures is less than 100 μm, preferably less than 20 μm and particularly preferably less than 1 μm. The person skilled in the art can flesh out the term “flat”, as in particular this specifies that the areas and the conductor structures have no elevations. This is particularly necessary, as the areas and the conductor structures are part of a first surface which, in particular, are located parallel to the second surface of the touch screen. That is to say, in particular, there is a planar contact between the first and second surface.

It must be noted here that the electrically conductive layers which are applied to a substrate of the information carrier can penetrate into the substrate. Methods, with which the layer thickness of such layers can be determined, are sometimes known to the average person skilled in the art.

The information carrier can be manufactured particularly by an additive, subtractive and/or semi-additive method, particularly preferably a printing method, and especially preferably a cold film transfer method. The information carrier can preferably be manufactured using a mass production method, whereby it is preferred that it is manufactured using a transfer method, particularly preferably a transfer film method and quite particularly preferably a cold film transfer method. Methods of this kind are known to the person skilled in the art, and he knows that it is possible to apply a substance (preferably the electrically conductive layer) to the substrate in a structured manner, particularly in some areas, by means of a printing method. Here, the substrate is not covered by the electrically conductive layer over its whole area; instead the layer lies only in or on certain regions of the substrate. Other methods for the structured application of a layer can, of course, also be used. Advantageously, the applied or introduced electrically conductive layer can be modified in some areas, particularly in the structure, by means of additive, semi-additive and/or subtractive methods, preferably by inkjet printing and particularly preferably by laser printing. However, it is also preferred that the information carrier is produced by means of a printing method known to the person skilled in the art. Within the meaning of the invention, printing methods are in particular all methods with which electrically conductive layers can be applied and/or introduced to substrates. In particular, within the meaning of the invention, printing methods denote methods for printing or duplicating. Examples of printing methods include mechanical printing methods, photo mechanical printing methods or electrostatic copying methods, in particular letterpress, gravure, flat printing or offset methods.

It is preferred that the electrically conductive areas and the electrically conductive conductor structures have an electrical surface resistivity or a specific surface resistivity of less than 1000 ohms/square, preferably less than 300 ohms/square, particularly preferably less than 50 ohms/square. Within the meaning of the invention, the surface resistivity in particular describes the electrical resistance of the electrically conductive layer which is applied to the substrate and therefore in particular of the electrically conductive areas and of the electrically conductive conductor structures. The surface resistivity is also known as specific resistivity and, in particular, can be calculated as follows:

R_{□}=ρ/d

where the specific resistance (ρ) is in ohm*m and a thickness (d) of the layer is in m. As, in practical applications, the real layer thickness is difficult to determine (particularly in the case of printing methods where part of the electrically conductive printing ink penetrates into the substrate), a two-dimensional consideration of the surface resistivity has proved valuable. In addition, the surface resistivity is given by:

$$R □ = \frac{R * b}{l}$$

where
R=ohmic resistance
b=Conductor track width
l=Conductor track length
(for rectangular conductor tracks)

The surface resistivity can therefore also be specified in ohms/square. Taking into account these assumptions, it is particularly preferred to use the following layers and surface resistivities: Offset or flexo-printed graphite/carbon layers: 300-1000 ohms/square; screen-printing graphite/carbon layers: 10-300 ohms/square; aluminum in cold film transfer methods: 1-10 ohms/square; screen-printed silver conductive paste: 20-50 mohms/square; etched copper: 5-40 mohms/square. Values of more than 1000 ohms/square can also be realized depending on the layout of the applied structures, but in general, the higher the resistance, the worse the detection and the higher the inaccuracy of recognition.

The electrically conductive areas and the electrically conductive conductor structures are, in particular, used in such a way that, as a result of contact with the touch screen, they give rise to signal changes which can be evaluated by the controller (deviations from the quiescent state of the system are achieved by overlapping with the cross-over points of the multi-layer conductor tracks within the touch screen) and are detected thereby as an input. The controller then evaluates the resulting signal changes and can therefore determine the coordinates of the touch. As well as single-touch detection, multi-touch detections are also possible so that a plurality of conductive areas can initiate a plurality of touch events on a touch screen.

Surprisingly, it is possible to determine and to characterize the touch event initiated by an information carrier on a touch screen by means of the method according to the invention. Nothing of this kind is described in the prior art so that the method relates to a new technical field. For example, characterization includes the interpretation of the determined positions, orientations and/or extensions of the touch event alone or as a totality. In further embodiments of the invention, this information can be specifically processed further using information technology.

Within the meaning of the invention, the surface of the information carrier is in particular designated as the first surface. It is known to the person skilled in the art that a touch screen has a surface by means of which inputs can be made. Within the meaning of the invention, this surface is in particular designated as the second surface and is the surface with which the first surface of the information carrier interacts.

The information carrier is preferably disposed within the spatial vicinity of the touch screen. Within the meaning of the invention, a spatial vicinity signifies in particular that there is a direct contact or indirect contact between the touch screen and an information carrier, and the information carrier or parts or areas thereof functionally interact with the touch screen. This interaction can be achieved by different physical operating principles or combinations thereof, e.g. capacitive, interactive, electromagnetic or electronic. The particular interaction depends on the touch screen type which is available in a specific case, i.e. on the touch screen technology. Preferably, the electrical variables or characteristics of the touch screen are changed by the interaction of the electrically conductive areas of the information carrier and the electrodes of the touch screen. Within the meaning of the invention, electrical variables in particular include electrical field strength, capacitance, voltage, current and resistance without being limited thereto.

Preferably, at least one touch event is initiated on the touch screen as a result of the capacitive interaction for example. Within the meaning of the invention, a touch event, also referred to as touch-event, touchevent or touch-occurrence, in particular signifies an initiation of an event on the touch screen.

Surprisingly, by means of the method, it is possible for the first time to assign information carriers, in particular capacitive information carriers, to data records in an information-processing system by using the touch screen to collect information which is then processed further in order to generate a value which enables the assignment in an information-processing system. Surprisingly, the method can be used on single-touch and multi-touch events.

It is known to the person skilled in the art that microcontrollers or comparable electronic circuits are used in conjunction with appropriate software to determine the position of finger inputs on a touch screen. At least one touch event is generated by the finger input, which can likewise be simulated by a capacitive information carrier. Surprisingly, the invention now uses the fact that, for example, suitable capacitive information carriers generate a correlation of positions of finger inputs on a touch screen which make these recognizable. To produce this recognition ability, the positions of the touch events provided by the preferred method are used and processed in any repeatable manner, thus enabling a structure which represents the original information carrier to be determined. It can also be advantageous that the positions, orientations and/or extensions of the touch events are combined to form a set. Within the meaning of the invention, in particular a set is a combination of the touch events initiated on the touch screen to form a totality. The special feature of the preferred method is that this structure or set is preferably always identical, or however at least similar, for each information carrier, as a result of which an association or at least a similarity with any data record in an information-processing system can be determined.

Further, it can be preferred that a point cloud is formed from the positions, orientations and/or extensions of the touch events in relation to one another.

Furthermore, it is preferred that a frequency polygon is formed from the positions, orientations and/or extensions of the touch events. Within the meaning of the invention, a frequency polygon in particular describes a locus of a path which is made up of an infinite number of straight sections. Furthermore, it is preferred that the frequency polygon, the set of touch events or the point cloud is assigned to a data record in an information-processing system.

Advantageously, the touch events can be determined by means of device drivers, OS API and/or software API. The OS API is the programming interface which is provided by the operating system. The software API is the programming interface which is provided by a software system to other programs for connecting to the system. In addition, it can be preferred that the touch events are determined by means of software in a software API.

However, it can also be preferred that the touch events are determined by means of software in an OS API.

Furthermore, it can be preferred that the touch events are determined by means of software by a device driver. Within the meaning of the invention, a device driver in particular designates an interface between software and hardware, i.e. essentially a communications channel between device and operating system. In the broader sense here, it is also understood that it is possible to integrate actual “software” in the sense of algorithms or general data processing in the device driver. The same applies to the possibility of carrying out such data processing in the device itself—for example the so-called touch controller—by means of firmware.

With a WebAPI, as a preferred form of a software API, a web server application is supplied and run on the device which contains the touch screen in a software API or a JavaScript interpreter of the web browser. Advantageously, it is therefore possible to separate the supply and execution of the program.

Within the meaning of the invention, a touch event can be designated as UITouch, UITouch object, UITouch event, NSTouch, NSEvent, NSTouch object, Touch (e.g. in accordance with information technology class references for common software development environments), that is to say as the information technology representation of the interpretation of the controller which the touch screen evaluates electrically. This UITouch object has different characteristics, such as for example an X-coordinate, a Y-coordinate, a length extension, a width extension and a direction of extension.

As well as an electrically non-conductive substrate, the information carrier preferably includes electrically conductive areas which can be arranged in a structured manner. It is preferred that the information carrier includes an electrically non-conductive substrate selected from the group comprising plastic, paper, cardboard, wood material, film, composite material, glass, ceramic, printed circuit board material, textiles, leather or a combination thereof. In particular, the substrate is an electrically non-conductive material, which is preferably flexible and has a low weight. Substrates which are translucent or which are impervious to light can be used.

In an embodiment of the invention, an electrically conductive area is applied to the substrate, wherein the area is preferably provided as a surface or as a structure. The area can take any form and can be designed in different ways. For example, round, angular or oval surfaces or combinations can be present on the substrate. Complex geometrical shapes can also be realized or a plurality of individual layers or, in particular, areas can be combined with one another. It can be preferred that a plurality of electrically conductive areas is applied to a substrate. Advantageously, shape, orientation, number, alignment, spacing and/or position of the areas can vary.

The electrically conductive areas are preferably a metal layer, a layer containing metal particles, a layer containing electrically conductive particles, electrically conductive polymer layer or a layer comprising at least one combination of these layers. In general, any material which is electrically conductive can be used. Furthermore, metal-organic materials comprising a compound of metal and carbon can also be used. Within the meaning of the invention, metals particularly denote chemical elements which, unlike non-metals, are to be found in the periodic system to the left of the diagonal dividing line starting with the element beryllium (2nd group) to polonium (16th group) as well as their alloys and inter-metallic compounds (including Laves phases, Heusler phases, Zintl phases, Hume-Rothery phases, NiTi, Co5, Nb3Sn or Ni3Al) with characteristic metallic properties. Among others, metals include aluminum, lead, chromium, iron, gold, indium, cobalt, copper, magnesium, manganese, molybdenum, sodium, nickel, silver, titanium, tungsten, zinc or tin. Metal oxides, such as indium tin oxide for example, can also be used. This is particularly advantageous because, although it is electrically conductive, it is also transparent and therefore no surface on the touch screen is optically masked.

Within the meaning of the invention, polymers particularly denote a substance which is made up of a collective of chemically uniformly structured macromolecules (polymer molecules) which however are usually different with regard to degree of polymerization, molecular weight and chain length. The polymers are preferably electrically conductive. With such uniform polymer materials, all macromolecules preferably have the same structure and differ only in their chain length (degree of polymerization). Polymers of this kind can be referred to as polymer homologs. Polymers can be selected from the group comprising inorganic polymers, metal-organic polymers, fully or partly aromatic polymers, homopolymers, copolymers, biopolymers, chemically modified polymers and/or synthetic polymers. Polymers selected from the group comprising paraphenylene, polyacetylene, polypyrrole, polythiophene, polyaniline (PANI), PEDOT are particularly preferred.

Furthermore, electrically conductive substances in particular include carbon black or graphite particles. Carbon black describes a manifestation of carbon which is formed during incomplete combustion or thermal decomposition of carbon-containing substances in vapor form. Carbon black can be used in powder or granulated form. Carbon black preparations, for example in the form of liquid, pasty or solid carbon-black-solvent concentrates in which the carbon black is uniformly dispersed, can also be used. Depending on the method of manufacture and raw material, carbon black can also contain hydrogen, nitrogen or oxygen as well as carbon. Carbon black has an outstanding pigment characteristic as well as insolubility in all solvents, resistance against most chemicals, resistance to fading, high color depth and color strength. Within the meaning of the invention, graphite particularly denotes a stable modification of carbon. Graphite is a good electrical conductor due to a layer-type structure. CNTs (carbon nano tubes) are similarly suitable for implementing the conductive areas.

The electrically conductive areas are preferably applied to the substrate in a structured manner. Within the meaning of the invention, structured particularly denotes that the electrically conductive areas do not fully but only partially cover the substrate.

The information carrier can advantageously be fixed to or on the touch screen by means of an interlocking, friction and/or bonded attachment so that at least one electrically conductive area is in contact or at least in spatial convergence with the touch screen, as a result of which there is an interaction with the touch screen. The attachment to the touch screen is preferably designed to be reversible. That is to say, the state before attachment can be reproduced without permanently changing the input element or the touch screen or its environment. Contact is preferably made by a consumer, operator or “user”. He uses the information carrier to make contact for as long as is necessary to carry out the method. In this way, within the meaning of the invention, a method is realized in which the conductive areas can be detected in less than 30 seconds, preferably less than 10 seconds and particularly preferably less than 1 second. This enables touch events to be initiated quickly and accurately, as a result of which the touch screen can continue to be operated and used.

It can also be preferred that the substrate of the information carrier is fixed to the touch screen using the adhesive label principle (e.g. Post-it Notes) or other adhesive bonding agents. Furthermore, it is conceivable for other elements to be used for temporary or permanent fixing of the information carrier to the touch screen. All forms of adhesive (electrically conductive and electrically non-conductive) or glues, rubber bands, pasted labels, insertion aids, clamps etc. are conceivable. This enables good contact according to the invention between information carrier and touch screen and fault-free operation, as slipping or sliding is prevented.

The at least one information carrier is brought into contact with the at least one touch screen, wherein the contact can be static and/or dynamic. Here, a static contact describes that no or insignificant relative movement takes place with respect to the touch screen, particularly at the moment of evaluating the information carrier. In contrast, a dynamic contact describes that in particular a relative movement can take place during the evaluation of the information carrier. The dynamic contact can also be a swiping or other dynamic movement for example. According to the invention, the contact can also include a convergence.

In a particular embodiment of the invention, a method is provided in which the initiated touch events with information such as X-position, Y-position, width, height, extension, elliptical extension, diameter, pressure and/or angle are used for coding, correction and/or characterizing the information carrier by means of their combination.

Furthermore, it is preferred that the device which contains the touch screen is selected from the group comprising smart phones, cell phones, displays, tablet PCs, tablet notebooks, touchpad devices, graphics tablets, televisions, PDAs, mobile music play-back devices and input devices.

Advantageously, the arrangement of the conductive areas can be assigned to a data record in an information-processing system. Within the meaning of the invention, data particularly denotes entities formed by characters or continuous functions which, as a result of known or assumed conditions, represent information primarily for the purpose of processing and as a result thereof. The data or information are (machine) readable and processable and can be used for communication, interpretation or processing. The person skilled in the art of information is aware of what is meant by the term “data”. In particular, a data record denotes a compiled unit of data or data fields.

In a preferred embodiment, at least one touch event is assigned to a data record or a plurality of data records in a data-processing system, wherein the data record changes or the data records change. Advantageously, at least one touch event can be assigned to or initiate an action of a data-processing system. This action applies particularly to non-networked data-processing systems and particularly preferably to networked data-processing systems. Here, it can be preferred that the arrangement of the conductive areas alone and/or in combination with information in the OS API initiates actions in an information-processing system. For example, this can be carried out in that a process monitors the input in the initial state of an information-processing system at run time, for example when displaying the so-called homepage or desktop, and only executes a pre-defined program if an information carrier is detected. For example, and without being limited thereto, an input by means of an information carrier is detected in that all information from the OS API in the form of typical human inputs, such as tapping, pointing, swiping or a so-called “pinch-to-zoom” gesture, is ignored and the remaining set of inputs, for example by means of one of the stated methods, is interpreted as an information carrier.

Furthermore, it has been shown that it can be distinguished whether a touch event has been initiated by a person or by an information carrier by means of certain characteristics of the touch event. By checking the consistency of the geometry of a touch event, it can be established whether this has been imitated by a human hand or by an information carrier, the geometry of which always remains constant. By means of a construct of different point sizes, it can be checked whether a touch event has been produced by an information carrier by comparing the probability of occurrence of the touch events with one another.

Furthermore, the touch screen can be divided into different parts, wherein the areas or parts are preferably assigned to one or more functions. For example, one area can read information carriers, while another exclusively accepts finger inputs. In addition, the same information carrier can call up different actions on different areas.

The invention is explained below with reference to examples and figures without however being restricted thereto. In the drawings:

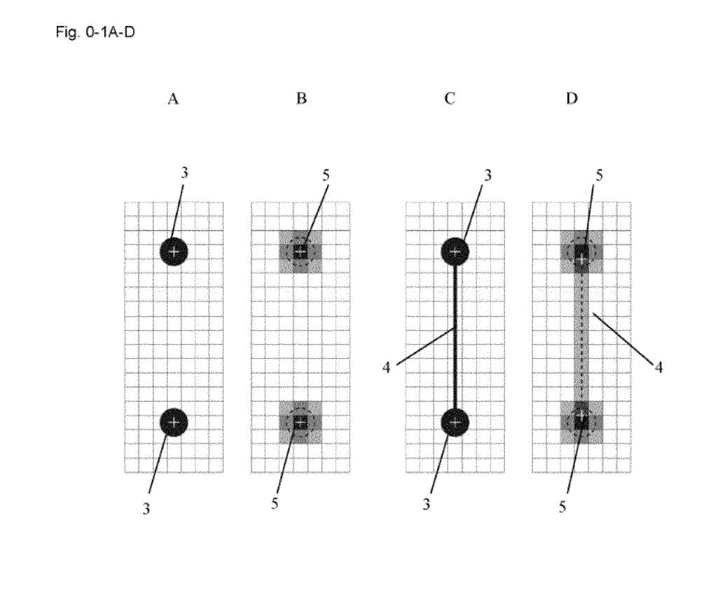

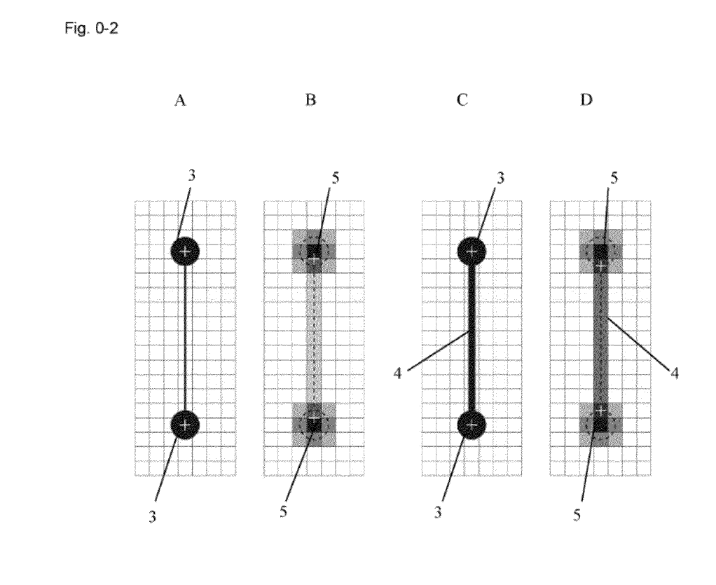

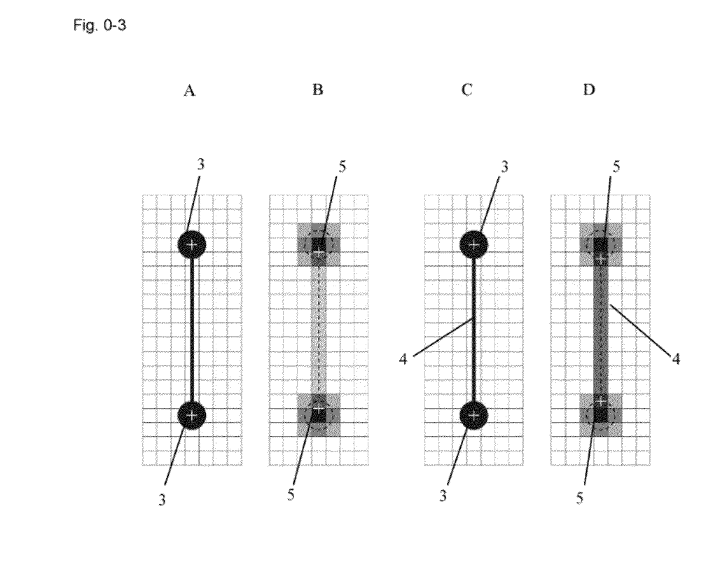

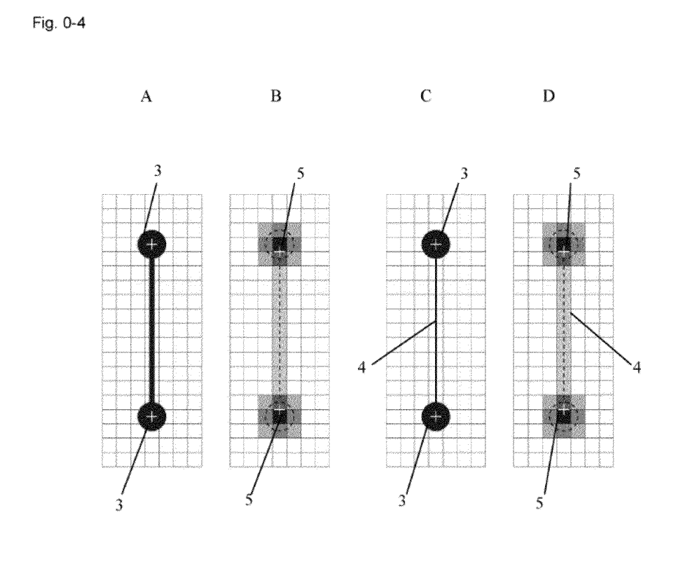

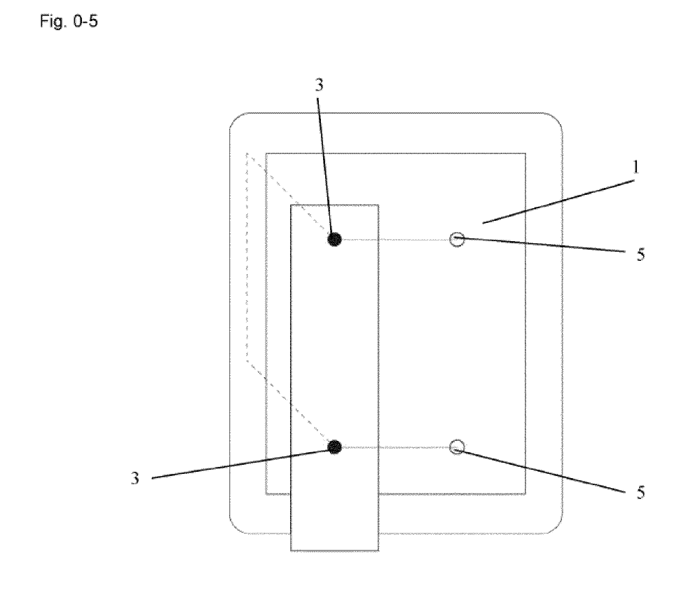

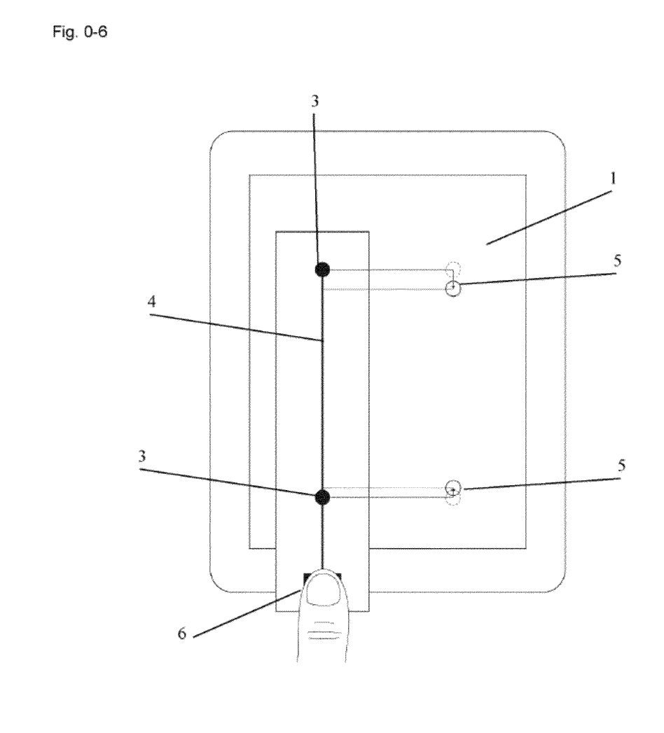

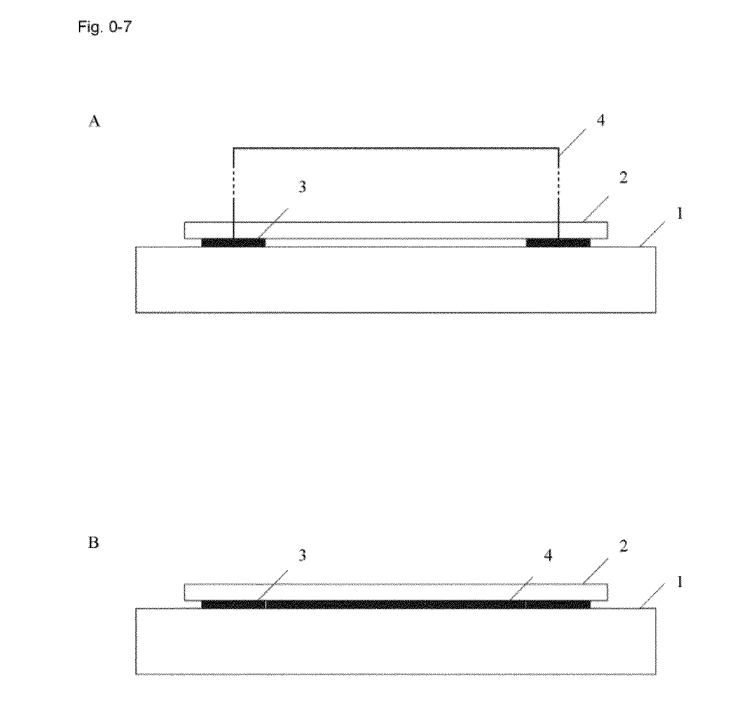

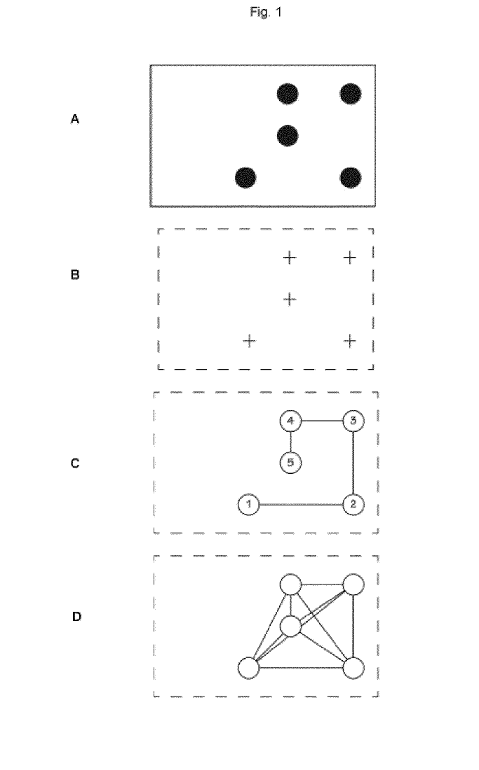

FIG. 0-1 A/D-FIG. 0-4 shows the prior art and preferred method

FIG. 0-5 shows the interaction between a touch screen and the prior art

FIG. 0-6 shows the interaction between a touch screen and a preferred information carrier

FIG. 0-7 shows a cross section of FIG. 0-5 and FIG. 0-6

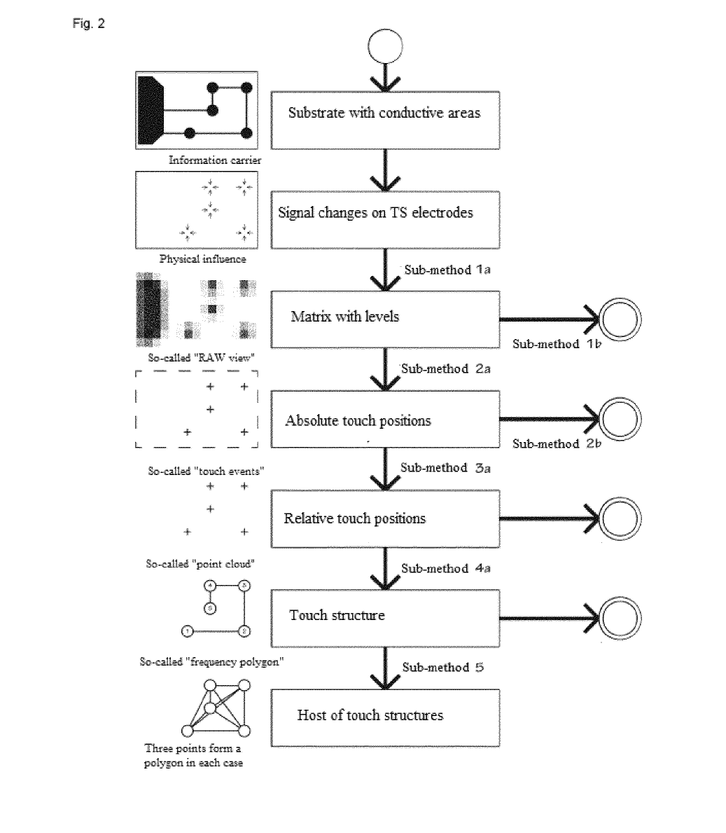

FIG. 1A-D and FIG. 2 show a preferred method for determining touch events

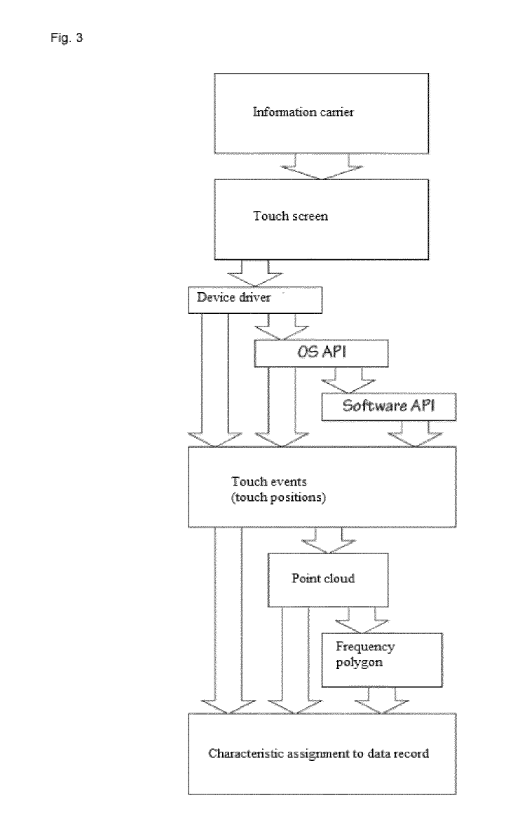

FIG. 3 shows a further preferred method for determining touch events

FIG. 4 shows further characteristics of a touch event

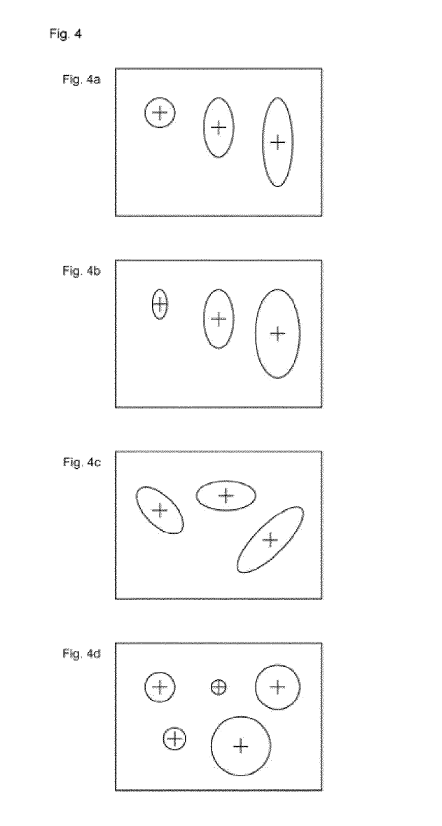

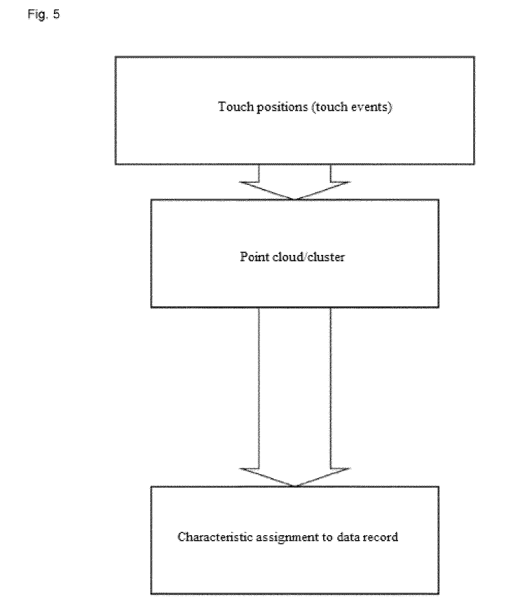

FIG. 5 shows the creation of a characteristic assignment

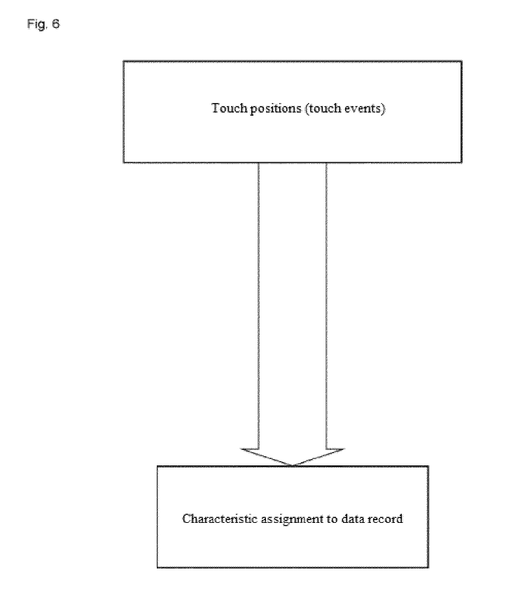

FIG. 6 shows a further example of the generation of the characteristic assignment

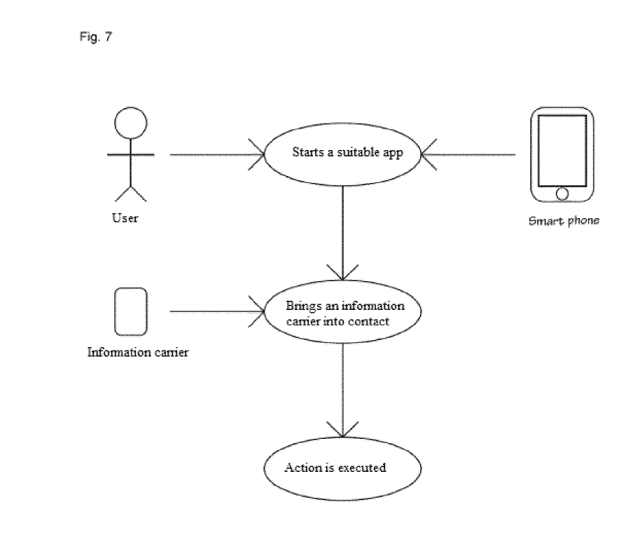

FIG. 7, FIG. 8 show an example of initiating an action

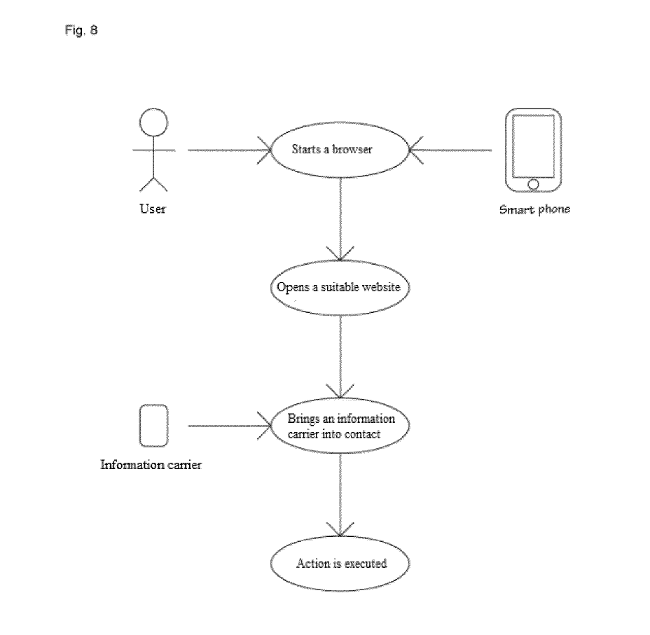

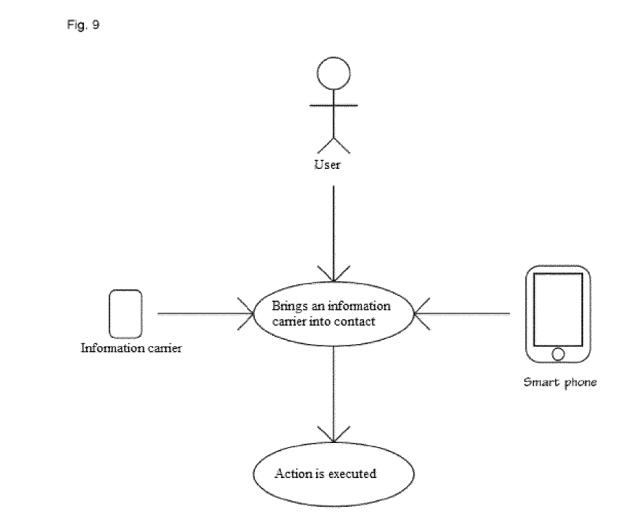

FIG. 9 shows the activation of an action by a combination with an information carrier

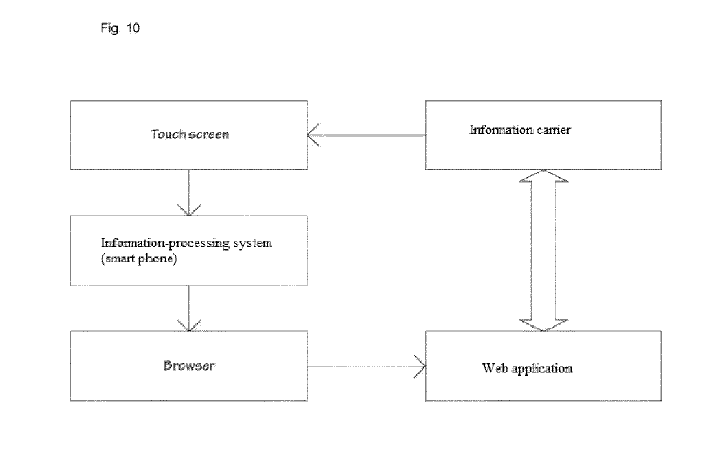

FIG. 10 shows the information flow for the assignment of information carriers to values in a web application

FIG. 0-1 A/D-FIG. 0-4 show the prior art and a preferred method. Here, FIGS. A and C show the prior art or a preferred information carrier, and FIGS. B and D the touch events 5 which are produced in each case. Distortions which are relevant to the preferred method are produced as a result of the preferred structure of an information carrier. Within the meaning of the invention, a distortion also describes a shift in the touch point. A particular advantage of the preferred method is that, with the structure of the preferred information carrier, not only is the electrical principle of operation of a touch screen affected, but the downstream evaluation by software following finger inputs can also be used for the method. Two touch points 3 in any technology of the prior art are shown under A and B. These cannot be evaluated using the preferred method. The touch points 3 are connected (for example by wiring via a second plane). The touch points 3 therefore affect the electrics of the touch screen, thus causing a level change which behaves proportionally to the overlapping electrode surface. The evaluating software of the touch screen or of the electrical device which contains the touch screen consequently receives a matrix of level values and can determine the center of the touch points 3 by means of averaging algorithms. From this, the coordinates of the touch event 5 are determined. In this case, they correspond to the real center of the applied touch points 3 on the touch screen.

In the right-hand part of the figure (C, D), the two touch points 3 are connected by means of a connection 4 (in particular an electrically conductive conductor structure) in the same plane with the touch points 3. Because of their conductivity, the electrodes of the touch screen are affected in a similar way to the touch points 3 themselves. This effect causes a (small) change in level in the electronics at the points in question. Particularly at points where a level change is already active (for example in the vicinity of the touch points 3), this structure changes the matrix with level values for the evaluating software. This special form of level change now causes a deliberately “incorrect evaluation” of the coordinates of the touch event 5, as, within the meaning of the invention, these coordinates are now “distorted” in the direction of the connections 4 (conductor structures).

The level change, which is caused by the connections 4 in the same plane of the touch points 3, is proportional to the conductivity of the material of touch points 3 and connections 4. In particular, a high conductivity causes a large level change, while a low conductivity effects only a small level change. In addition, advantageously, the width of the connection 4 can likewise act proportionally on the magnitude of the level change. There is therefore a significant distinction from the prior art, as the structure of an information carrier is designed particularly so that it not only suitably affects the electrics of the touch screen, but also so that distortions are specifically caused in the downstream evaluation by software which is then specifically used to recognize the information carrier by means of the preferred method. With the prior art, the electrical conductivity is evaluated differently, i.e. the level of the amplitude changes depending on the material so that no point shifting occurs. With the preferred method, different conductivities cause different distortions which are evaluated, i.e. the distortion has a different effect in each case with different materials.

Preferred information carriers are shown with different line thicknesses of the connections 4 in FIG. 0-2 A and C, and the corresponding initiated touch events 5 are shown in FIGS. B and D. It was also surprising that even changing the line thickness in an information carrier leads to a distortion which can be used by the preferred method (FIG. 0-2). That is to say, different touch events can be produced by changing the line thickness.

FIG. 0-3A-D is structured in a similar way to FIG. 0-2, wherein materials with different conductivities have been used rather than the line thickness, and a distortion which can be evaluated by means of the preferred method likewise occurs.

A preferred information carrier according to FIG. 0-3 is likewise shown in FIG. 0-4 A-D. Here, the line thickness and the conductivity have been chosen so that the same distortion results for different characteristics of line thickness and conductivity.

An interaction between a touch screen and an object according to the prior art is shown in FIG. 0-5, and an interaction between a touch screen and a preferred information carrier is shown in FIG. 0-6. In the prior art, a touch point 3 is applied to a touch screen 1; the connections lie orthogonally with respect to the surface of the touch screen, for example, and generate touch events 5 without distortion. On the other hand, with a preferred information carrier which can be read by means of the preferred method, a distortion of the touch events 5 on the touch screen 1 is achieved by the connections 4 of the touch points. A user touches the information carrier, preferably by means of a coupling surface 6. In particular, a coupling surface on a preferred information carrier is a separate touch surface for the user so that the electrically conductive areas and conductor structures are connected to the electrical potential of the user.

FIG. 0-7 shows a cross section of FIG. 0-5 (A) and FIG. 0-6 (B). A cross-sectional view of the prior art shows that the touch points 3 do not lie in one plane with the electrical connection (conductor structures) 4 on the substrate 2 which constitutes a significant difference from the invention. The preferred method is used for detecting one or more electrically conductive areas of one or more information carriers, wherein the electrically conductive areas (touch points 3) and the electrically conductive conductor structures 4 lie in a first surface parallel to the second surface of the touch screen 1.

FIG. 1A-D and FIG. 2 show a preferred method for determining and characterizing touch events. FIG. 1A shows a capacitive information carrier. Here, the circles on the information carrier are conductive areas which are detected by the touch screen as finger inputs or touch events. Touch positions essentially have the characteristics X-position and Y-position. In addition, they can have further characteristics such as diameter and elliptical extension. Touch positions are linked to a coordinate system. The information relating to the touch events can originate, for example by means of software, from a device driver, an OS API or a software API. It is also preferable that this software is an API for processing touch inputs of an operating system or of a browser. Shown in a suitable coordinate system, the correlation of the finger inputs produced by the information carrier appears as in FIG. 1B. Without a coordinate system, the correlation of the touch events constitutes a point cloud which is already characteristic of the information carrier. A point cloud is defined in that the relationship which the points have to one another can be determined. This relationship is completely independent of the reference system. At the same time, a point cloud can be rotated and scaled at will. For example, the arithmetic midpoint of the structure can be determined and therefore also the finger input or the touch event which is furthest therefrom. This position of a finger input is the first point of the recognizable structure. The next point is now determined starting from the direction from the arithmetic midpoint towards the first point of the structure beginning from the first point as the center of polar coordinates in the mathematically positive direction of rotation. This is the second point. The next point in the mathematically positive direction of rotation is now sought starting from the direction from the second to the previous point with the center of polar coordinates at the second point. This determines the third point. This last step is repeated until all points have been found. Points which have already been found are no longer taken into account in the following steps. The result is a frequency polygon as shown by way of example in FIG. 10. A frequency polygon is a sequence of the directions and lengths to the subsequent points. Here, the whole frequency polygon can be constructed starting from one point by means of relative information alone. This structure can also be described as a sequence of directions and distances in accordance with the above steps. In this example, these are: Distance 40 mm, Angle 90°, Distance 32 mm, Angle 90°, Distance 24 mm, Angle 90°, Distance 16 mm and can be designated as sequence 40-90-32-90-24-90-16. An assignment in an information-processing system can now be made very easily by means of this recognizable structure which can be generated any number of times. In this example, the character string “40-90-32-90-24-90-16” can be assigned to a key of type VARCHAR in an SQL database. In order to make the structure traceable on the touch screen so that individual points of the structure can also disappear to reappear in a later measuring cycle, for example, it can be preferred to consider the structure as a host of polygons (FIG. 1D). A host of polygons is a set of polygons. In the minimum case, a polygon consists of 2 points; it is only meaningful in an application with 3 points. A host of polygons is necessary to follow the characteristic structure through a plurality of measuring processes. It is only meaningfully possible to detect information carriers which are larger than the touchscreen by means of a host of polygons. Here, every connection between two points represents an edge of a polygon. The structure is therefore always correctly maintained if a point is missing. The structure can also be rotated and translated without restriction. At least two points of the structure are required for rotation and, in a very restricted manner, as little as one point of the structure is sufficient for translation.

The detection and assignment of an information carrier by means of a touch screen is likewise shown in FIG. 2. The following method enables information carriers to be assigned to a data record by means of a RAW view.

Sub-method 1a: The touch controller cyclically checks one or more electrical variables between each pair of electrodes according to the capacitive touch screen structure provided in each case. If the check shows no change in the electrical variable or variables considered in each case, then no influence on the touch screen by a finger or an information carrier can be determined at this point. In this state, the information carrier is brought into contact with the touch screen.

Within the meaning of the invention, in particular but without being limited thereto, a form of display of measured levels for touch screens is designated as a RAW view or raw data view. As well as the level principle, other evaluation and display methods which can be processed in the same or a similar manner are conceivable. However, further remarks are restricted to the level principle by way of example.

The actual raw data are the set of measured levels per se. With modern touch screens, the electrodes are usually designed as a matrix in the form of rows and columns. A level can therefore be determined for each crossover of this matrix, and this is stored at the associated point as a level value, for example but not restricted thereto, in a two-dimensionally arranged set. The totality of the level values in this set is referred to in particular as “raw data”. A particular form of “raw data” is the display form as a so-called grayscale image, as this set of level values is very similar to matrix-based data types in digital image processing. This display is normally used in technology to represent the set of measured level values graphically. Another term for raw data is “RAW data” and another term for “raw data view” is RAW view”.

With touch screens, in the latest state of the art, the electrodes are usually designed as a matrix in the form of rows and columns. Here, as a rule, the electrodes in the rows are assigned the role of transmitting electrodes or the role of receiving electrodes. The electrodes in the columns are usually assigned the other role in each case. Within the meaning of the invention, the respective electrode in the row and the respective electrode in the column are referred to, particularly together, as an electrode pair. Compared with the total area of the electrodes, there are therefore very small overlapping surfaces of the two electrodes between the electrode roles. The overlapping surface of the two electrodes is referred to in particular as the crossing point.

As a result of the conductive areas of the information carrier, the value of the electrical variable between the electrodes of the touch screen changes at the point at which the conductive structure overlaps these very electrodes. The touch controller evaluates these changes in the electrical variables for each electrode pair. As the electrodes are designed as rows and columns, a two-dimensional set of levels, similar to a grayscale image, can be determined. This image is referred to as the “RAW view”.

Sub-method 1b: With this RAW view, it is now possible to determine an information carrier by now searching for the local maxima and normalizing these with respect to one another depending on their position. A profile of the information carrier found in this way can be recognized and also differentiated from other information carriers. Furthermore, information carriers can be assigned to a data record by means of touch events which are furnished by the touch controller and/or operating system. Sub-method 2a: The method includes all steps of sub-method 1a and in addition the following steps: In the RAW view, the touch controller and/or the operating system finds all points which probably represent a finger input, determines for these their position on the display in a coordinate system and further characteristics such as, for example, but without being restricted thereto, diameter or elliptical extension. The set comprising this information is referred to as “touch events”.

Sub-method 2b: The coordinates of these “touch events” are now used to form a set of coordinates on the touch screen. This set is characteristic of each information carrier and therefore enables other information carriers to be recognized and differentiated. Furthermore, advantageously, information carriers can be assigned to a data record by means of a point cloud:

Sub-method 3a: The method includes all steps of sub-method 2a and in addition the following steps: The set of coordinates of the touch events are normalized by taking into account only their position with respect to one another, and therefore the orientation of the whole set is insignificant. The normalized position of the coordinates with respect to one another is referred to as a “point cloud”.

Sub-method 3b: This point cloud is now characteristic of each information carrier and therefore enables other information carriers to be recognized and differentiated. It is now particularly advantageous here that the information carrier can be positioned substantially freely on the touch screen, as the absolute position of the touch events is no longer relevant. Furthermore, the information carrier can be assigned to a data record by means of a touch structure.

Sub-method 4a: The method includes all steps of sub-method 3a and in addition the following steps: A normalized graph is now formed from the point cloud. This is carried out either in that all points are connected to form a frequency polygon using a rigidly defined method, or in that all points are connected to form a free graph with actual crossing points. Both methods produce a so-called touch structure.

Sub-method 4b: This touch structure is characteristic of the information carrier and can therefore be recognized and differentiated from touch structures which are formed by other information carriers.

Sub-method 5: The method includes all steps of sub-method 4a and in addition the following steps: In addition to the touch structure, either every combination of, for example, 3 points are combined to form polygons, or, for example, 3 adjacent points are repeatedly sought until all points are connected in polygons without intersecting edges. Preferably, here, a polygon consists of 3 points and is therefore a triangle. Surprisingly, this results in a host of touch structures which can be calculated very efficiently with information-processing systems and which is particularly suitable for determining the movements of an information carrier by means of a touch screen.

FIG. 3 shows the information flow of a set of preferred methods for assigning information carriers. Here, the physical structure of the information carrier is electrically evaluated by the touch screen. The touch screen then makes the information obtained by the evaluation available to a data-processing system by means of a device driver. Here, in one of the preferred cases, the touch events can be determined directly. In a further preferred case, the touch events can likewise be determined by processing the touch screen information further by means of an OS API, that is to say a software interface of the operating system. Furthermore, it is possible to determine the touch events from the information from the OS API by means of a software API, that is to say a software interface which is provided by an application. These touch events have certain characteristic properties such as, for example, X-position, Y-position, width, height, extension, diameter, angle. From this point in the method, in a preferred form, these touch events can be brought directly to a characteristic assignment, or in another preferred embodiment combined to form a point cloud in order to thus generate a characteristic assignment. In a further preferred embodiment, this point cloud is additionally linked to form a frequency polygon in order to likewise generate a characteristic assignment.

FIG. 4a to FIG. 4d show the determined absolute touch positions of four different information carriers with the additionally determined further characteristics such as diameter and elliptical extension.

4a and 4b are therefore almost identical, but differ in the characterization of the conductive area at the first determined touch position. This difference in the elliptical extension still enables the two information carriers, which represent identical touch positions, to be differentiated.

FIG. 4c shows an information carrier with different elliptical extensions of the determined absolute touch positions. Also worthy of note are the identical elliptical extensions of the first and the second determined touch position which, however, differ in their determined angle.

FIG. 4d shows an information carrier with different diameters of the determined absolute touch positions.

The further characteristics determined in this way can be used to draw conclusions relating to the quality of the read process. If it is assumed that all touch positions have been generated by identical circular conductive areas, then, based on the differences in the further characteristics of the absolute touch positions, resulting from the actually identical conductive areas, it can be concluded that the determination of the absolute touch positions was subject to error.

The further characteristics can also be used for coding for example. For example, and without being restricted thereto, such coding can be realized in that each touch point conforms to one of two possible forms. As an example, both forms are ellipses, the extension of which is twice as long as it is wide. The two forms differ in that the longitudinal axis of the first form is aligned at 45° to the left of the orientation of the information carrier, and the longitudinal axis of the second form is aligned at 45° to the right of the orientation of the information carrier. Surprisingly, further information can therefore be coded by means of the change in form of a touch point. Within the meaning of the invention, a touch point is in particular an electrically conductive area which generates one or more touch events on the touch screen.

FIG. 5 shows a variant for a characteristic assignment of touch events to a data record. A preferred method of determining a characteristic assignment from a point cloud is to determine the distance between each pair of points in the point cloud, to record each of these distances in a list, and to sort this list by the magnitude of the distances to thus form a characteristic profile. This profile is always characteristic of this point cloud regardless of the rotation of the point cloud. In a special case, the distances in the list of distances are normalized to the greatest distance in order to also achieve independence from the scaling of the point cloud. As this profile is characteristic of a point cloud and a point cloud is characteristic of an information carrier, then the profile is also characteristic of the information carrier. If the characteristic profile of two non-identical information carriers is formed, then these can be differentiated based on their respective characteristic profile. Likewise, two identical information carriers can be similarly recognized on account of their identical characteristic profile.

FIG. 6 shows a further preferred variant for generating the characteristic assignment. A method for directly generating a characteristic assignment to a data record from the touch positions provided by the device driver, the OS API or the software API is to position the information carrier exactly and repeatedly on the touch screen. The touch positions provided in this way can be repeatedly assigned to the information carrier by means of a database.

FIG. 7 and FIG. 8 show use cases of the present invention as used in practice. These are, for example, a combination of an application (FIG. 7) or a browser (FIG. 8) and an information carrier. A user activates an application or a program or a browser on a device which has a touch screen. The application (app), which can also be referred to as application, and the browser expect a further input at this time following successful start-up. As an example, the further input can be by means of an information carrier which is brought into contact with the touch screen and executes an action by means of a capacitive interaction, wherein the software API, OS API or the device driver is used to assign the information carrier to a data record in an information-processing system.

FIG. 9 shows the activation of an action by a combination of the device containing the touch screen with an information carrier. Furthermore, it can be advantageous when a user is given access to an application, a browser or an action when the user brings the information carrier into contact with the touch screen.

FIG. 10 shows an aspect of the technical solution of the assignment of physical information carriers to values in an application or a so-called web application (double arrow). Here, the physical assignment of the information carrier is made available to the information-processing system (e.g. a smart phone) and to the software API of a browser, or to a JavaScript environment of a web application, by means of the touch screen or touchscreen as the physical intermediary (arrow chain).

### LIST OF REFERENCES

1 Touch screen
2 Substrate of information carrier
3 Touch point
4 Conductor structures
5 Touch events
6 Coupling surface

1. A method for detecting one or more electrically conductive areas of one or more information carriers comprising:
a. bringing, at least in some areas, the conductive areas of a first surface of one or more information carriers into contact with a second surface of a touch screen,
b. initiating one or more touch events by bringing the conductive areas into contact with the second surface in accordance with (a), and
c. determining positions, orientations and/or extensions of the touch events,
wherein the conductive areas are connected to one another via electrically conductive conductor structures and the conductor structures and the conductive areas lie in the first surface parallel to the second surface of the touch screen.

2. A method for detecting one or more electrically conductive areas of one or more information carriers comprising:
a. bringing, at least in some areas, the conductive areas of a first surface of one or more information carriers into contact with a second surface of a touch screen,
b. detecting the electrically conductive areas and conductor structures via the touch screen and manipulating electrical variables of the touch screen via the conductive areas and conductor structures of the information carrier,
c. evaluation of raw data, RAW view and/or a matrix with levels from the elicited manipulation, wherein the conductive areas are connected to one another via the electrically conductive conductor structures and the conductor structures and the conductive areas lie in a first surface parallel to the second surface of the touch screen.

3. The method as claimed in claim 1, wherein the positions, orientations and/or extensions of the touch events are combined to form a set.

4. The method as claimed in claim 3, wherein a point cloud is formed from the positions, orientations and/or extensions of the touch events in relation to one another.

5. The method as claimed in claim 2, wherein one or more frequency polygons are formed from the positions, orientations and/or extensions of the touch events.

6. The method as claimed in claim 2, wherein the one or more frequency polygons, the set of touch events or the point cloud are assigned to a data record in an information-processing system.

7. The method as claimed in claim 1, wherein the touch events are determined via a device driver, OS API and/or software API.

8. The method as claimed in claim 1, wherein the touch events are determined via software in a software API.

9. The method as claimed in claim 1, wherein the touch events are determined by via software in an OS API.

10. The method as claimed in claim 1, wherein the touch events are determined via software by a device driver.

11. The method as claimed in claim 1, wherein the conductive areas are detected in less than 30 seconds.

12. The method as claimed in claim 1, wherein the initiated touch events providing information comprising X-position, Y-position, width, height, extension, elliptical extension, diameter, pressure and/or angle is combined and the information carrier is coded, corrected and/or characterized via said combined information.

13. The method as claimed in claim 1, wherein the electrically conductive areas are substantially flat and a layer thickness of the electrically conductive areas and of the electrically conductive conductor structures is less than 100 μm.

14. The method as claimed in claim 1, wherein the electrically conductive areas and the electrically conductive conductor structures have an electrical surface resistivity of less than 1000 ohms/square.

15. The method as claimed in claim 1, wherein the information carrier is manufactured by an additive, subtractive and/or semi-additive method, particularly preferably a printing method, and especially preferably a cold film transfer method.

16. The method as claimed in claim 1, wherein the device which contains the touch screen is selected from the group comprising smart phones, cell phones, displays, tablet PCs, tablet notebooks, touchpad devices, graphics tablets, televisions, PDAs, mobile music play-back devices and input devices.

17. The method as claimed in claim 1, wherein the arrangement of the conductive areas is assigned to a data record in an information-processing system.

18. The method as claimed in claim 7, wherein the arrangement of the conductive areas alone and/or in combination with information in the OS API initiates actions in an information-processing system.

19. The method of claim 11, wherein the conductive areas are detected in less than 10 seconds or less than 1 second.

20. The method of claim 13, wherein the layer thickness of the electrically conductive areas and of the electrically conductive conductor structures is less than 20 μm or less than 1 μm.

21. The method of claim 14, wherein the electrical surface resistivity is less than 300 ohms/square or less than 50 ohms/square.
